(19) United States
(12) Patent Application Publication
(10) Pub. No.: US 2008/0270543 A1
(43) Pub. Date: Oct. 30, 2008

(54) E-MAIL SYSTEM THAT ALLOWS SENDER TO ATTACH RECIPIENT SPECIFIC METADATA

(76) Inventors: Anuradha Bhamidipaty, Bangalore (IN); Mukesh Kumar Mohania, New Delhi (IN)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/741,152

(22) Filed: Apr. 27, 2007

(51) Int. Cl. G06F 15/16

(52) U.S. Cl. 709/206

(57) ABSTRACT

A method detects a request from a user to append metadata to an e-mail message being addressed to a number of recipients. In response to the request, the method prompts the user to supply recipient specific information. The method generates the recipient specific metadata from the recipient specific information. The recipient specific information is different for different recipients and includes information regarding the action that is expected from the recipient, the relevance level of the e-mail, the description of the e-mail, and/or associated comments. Similarly, the recipient specific metadata is different for different recipients and the recipient specific metadata comprises fields for expected action, relevance level, description, and/or comments. The method adds the recipient specific metadata to the e-mail message and sends the e-mail message.

### BACKGROUND AND SUMMARY

The embodiments of the invention generally relate to e-mail systems, and more particularly to an e-mail system that allows senders to attach recipient specific information or metadata.

Exchange of e-mail messages is one of the most useful forms of communication today and is often used to send messages to multiple recipients. The recipients are included in the ‘To’, ‘Cc’ or ‘Bcc’ fields of an e-mail message as chosen by the sender. These fields provide a vague indication of the relevance of a message and the corresponding action to be taken by a recipient.

In some cases, the sender may wish to associate specific actions for a recipient. For example, when sending a multi-recipient e-mail a user may wish to state that one recipient should respond immediately, a second one should forward the content to another person while a third one should respond with detailed analysis in a week. When there are multiple recipients in the ‘To’ field, the user may wish to identify one person responsible for replying thus avoiding the confusion on who should respond back. Currently these actions are embedded in the e-mail message along with the content by including the specific actions against specific recipient names. However, there are drawbacks with these approaches. When the actions are included in the content of the e-mail, the recipient has to still read the message to locate it. Further, only after reading the message can the recipient understand the relevance of the message intended by the sender. When there are multiple recipients each in the ‘To’ and ‘Cc’ fields, a reply to this message from a recipient marked in the ‘To’ field will have all people in the ‘Cc’ field except for the message originator. This might be an incorrect assignment of relevance level.

In all the above cases, it would be advantageous to have an improved method for associating an e-mail with metadata specific to a recipient. This metadata can be used by the sender to indicate recipient specific action and/or different relevance levels (such as high importance, important but not urgent, read-only, must-read, FYI etc.) for each recipient. With the availability of such metadata, a recipient can prioritize to act on that new message accordingly.

This invention provides a method for including recipient specific metadata in e-mail messages. More specifically, the embodiments herein provide a method in an e-mail system for attaching recipient specific metadata. The method detects a request from a user to append metadata to an e-mail message being addressed to a number of recipients. In response to the request, the method prompts the user to supply recipient specific information.

The method generates the recipient specific metadata from the recipient specific information. The recipient specific information is different for different recipients and includes information regarding the action that is expected from the recipient, the relevance level of the e-mail, the description of the e-mail, and/or associated comments. Similarly, the recipient specific metadata is different for different recipients and the recipient specific metadata comprises fields for expected action, relevance level, description, and/or comments.

The method adds the recipient specific metadata to the e-mail message and sends the e-mail message. The metadata can comprise as a tag in the header of the e-mail message. Upon receipt of the e-mail, the information in the tag is parsed and the metadata appears separately from the body of the e-mail.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a method embodiment of the invention; and

FIG. 2 is a flow diagram illustrating a method embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, this invention describes a novel method for including recipient specific information or metadata in an e-mail message. This metadata is used to augment the content of the e-mail message with recipient specific context. For example, a sender can indicate specific actions expected from the different recipients of the message, identify different relevance levels for multiple recipients or may choose to add additional description/clarification for selected recipient(s). The e-mail client at the sender attaches the metadata as a tag in the header of the e-mail message. The tag is parsed by the e-mail client at the recipient's end.

The sender may choose to mark the metadata as visible to all or a selected few recipients, or mark it as private for use by only the intended recipient. The sender can optionally tag multiple recipients, possibly a sub-group of the total recipients, with the same metadata.

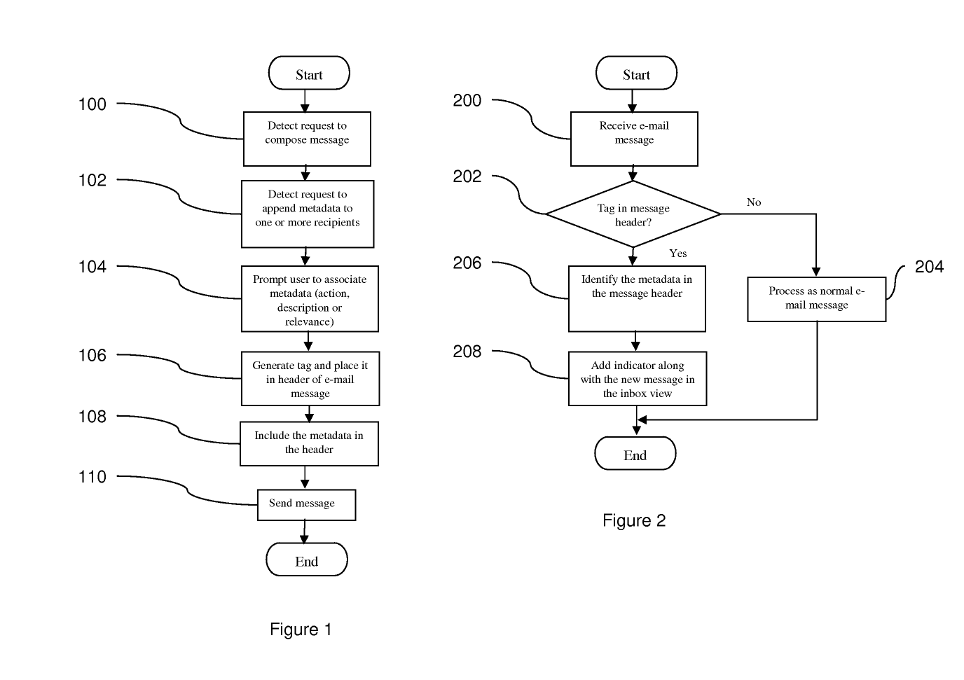

The flowcharts shown in FIGS. 1 and 2 represent the sequence of steps followed at the sender and recipients' e-mail clients. More specifically, FIG. 1 illustrates that the method starts in item 100 by detecting a request from a user to compose an e-mail message. Then, in item 102, the method detects a request from the user to append metadata to the e-mail message (that is being addressed to a number of recipients). In response to the request, the method prompts the user to supply recipient specific information (action, description, relevance, etc.) in item 104.

In item 106, the method generates the recipient specific metadata from the recipient specific information. The recipient specific information can be different for different recipients (or groups of recipients) and includes information regarding the action that is expected from the recipient, the relevance level of the e-mail, the description of the e-mail, associated comments, etc. Similarly, the recipient specific metadata is different for different recipients (or groups of recipients) and the recipient specific metadata comprises fields for expected action, relevance level, description, and comments.

The method adds the recipient specific metadata to the e-mail message in item 108 and sends the e-mail message in item 110. The metadata can comprise as a tag in the header of the e-mail message. Upon receipt of the e-mail, the information in the tag is parsed and the metadata appears separately from the body of the e-mail.

FIG. 2 illustrates that the e-mail message is received by the recipient (item 200) and a determination is made as to whether there is a tag in the message header in item 202. If there is no tag, the e-mail is processed as all other e-mails are processed, as indicated by item 204. If there is a tag, the metadata is identified in the message header in item 206 and an indicator is added along with the new message in the inbox view (item 208).

This method is illustrated by the following example. Assume sender A intends to send an e-mail message to recipients B, C, D, E and F. Each person accesses an e-mail client which is connected to an e-mail server. The following is a snapshot of the content of the message that A wishes to communicate.
To: B,C,D
Cc: F,E
Subject: Changes in travel policies
Hello All,
This is to inform you all about the changes in the travel policies decided in the OPS meeting last week. We need to re-work the current budget for our department to accommodate the travel expenses for the customer site visits. We have been asked to re-think the travel approvals we made last week for our department. . . .
The detail policy is present at http://www. . . . . . .
I would like to make a first pass on re-working our current budget and then pass onto you for further suggestions.
Regards,
A.

Assume that B, C and D are managers in A's group. User A wishes to express the following recipient specific information: B had recently made a travel approval and so he should be re-thinking if that travel is necessary. F is the communication persons and A wants to inform him of the policy changes as FYI. E is a finance manager of the department and A wishes to receive the details and break-up of the current budget from him. A puts E in the Cc field as E might already be aware of the policy changes.

To include the above recipient specific information, A selects a recipient and right clicks on it to activate a pop-up containing a ‘Metadata’ option. Selecting this option opens up a dialog box for associating the required metadata. For example, the following format is used by A to attach the metadata:
Recipient: B
Expected Action: Reply All
Description: Please reconsider if the travel to Tokyo is necessary
Relevance: Important, not urgent
Recipient: E
Expected Action: Reply
Description: Send the latest budget documents for the overall lab and department.
Relevance: Important, Urgent

With respect to the handling of metadata, metadata may be associated with the e-mail message as a tag also referred as e-mail header field. The tag can have fields such as <METADATA-ID, ACTION, DESCRIPTION, RELEVANCE>. A sender can associate multiple recipients with the same metadata. There can be a tag describing this association with fields such as, <RECIPIENT-ID, METADATA-ID, VISIBILITY-LEVEL>.

A sender can mark the metadata with different visibility levels such as private, public or protected (allowing only sub-group visibility) and the e-mail client may generate the tags accordingly to be placed into the e-mail header. Recipient specific information can be associated with any recipient included in the To, Cc or Bcc fields of the message. Only the recipient specific metadata information is sent to the mail user agent (MUA) of a recipient.

In one embodiment of the invention, the mail user agent generates the required tags to be placed into the e-mail header and the mail server takes the responsibility of parsing the header and sending the e-mail along with its copies to the recipients as desired by the visibility levels marked by the message originator. There can be other multiple ways of including recipient specific information in an e-mail message. The handling of the headers by the MUA and/or MTA is implementation dependent.

On receiving the message, the e-mail client will parse the information in the tag. An indicator, visual or textual, may be used to indicate that e-mail message has metadata associated with it. For example, hovering a mouse over the message opens a pop-up displaying the metadata.

Presently available e-mail clients can be implemented using an additional feature to support the above functionality. Further, the e-mail client can be configured with a predefined list of expected actions and relevance indicators that a user can select from a drop down. Example set of actions can be ‘Reply’, ‘Reply All’, ‘Reply Today’, ‘Forward’, ‘Must Read’ etc. Example relevance indicators are ‘Urgent’, ‘Important’, ‘Important and Urgent’, ‘FYI’ etc.

If an e-mail client is implemented using a legacy program and does not include the mechanism described in this invention, the message received will be processed as a normal message.

The mechanism described above can be extended to include default action and relevance action either pre-defined by a sender or can be dynamically determined by a knowledge base such as an organization hierarchy. For example, certain action and relevance levels may be associated with a message if it is sent by manager/senior manager of an employee.

The invention helps user associate recipient specific information in a multi-recipient e-mail message. This helps increase the expressivity of the message allowing the user to augment the content of the message with additional context for individual recipients. The invention helps save the time and effort of a recipient in understanding the expected action and resolving the ambiguity among multiple recipients on who should act (such as replying the message). The invention can also be used to associate recipient specific information even in a single recipient e-mail message thus allowing a clear separation of the content of the message from its metadata.

The metadata helps a user quickly identify a relevant important message and prioritize to act on the message accordingly. The invention allows the user to tailor and pre-define the metadata that could be appended to an e-mail message.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

1. A method in an e-mail system for attaching recipient specific metadata, said method comprising:
detecting a request to append metadata for at least one recipient of an e-mail message;
responsive to said request, prompting a user to supply recipient specific information;
generating said recipient specific metadata based on said recipient specific information;
adding said recipient specific metadata to said e-mail message; and
sending said e-mail message,
wherein said recipient specific information comprises expected action, relevance level, description and/or comments, and
wherein said metadata comprises one of a tag and header.

2-6. (canceled)
